(19) United States
(12) Patent Application Publication
(10) Pub. No.: US 2010/0313489 A1
(43) Pub. Date: Dec. 16, 2010

(54) cBN SINTERED BODY AND TOOL MADE OF cBN SINTERED BODY

(76) Inventors: Minori Teramoto, Hyogo (JP); Satoeu Kukino, Hyogo (JP); Tomohiro Fukaya, Hyogo (JP); Machiko Abe, Hyogo (JP)

Correspondence Address: MCDERMOTT WILL & EMERY LLP, 600 13TH STREET, N.W., WASHINGTON, DC, 20005-3096, US

(21) Appl. No.: 12/521,452

(22) PCT Filed: Jan. 15, 2008
(86) PCT No.: PCT/JP2008/050365

§ 371 Date: Jun. 26, 2009

(30) Foreign Application Priority Data
Jan. 15, 2007 (JP) 2007-005808

(51) Int. Cl. B23B 27/14; C04B 35/583

(52) U.S. Cl. 51/309

(57) ABSTRACT

A cBN sintered body excellent in chipping resistance and wear resistance in working difficult-to-machine centrifugally cast iron is provided. The present invention is directed to a cBN sintered body composed of a cBN component not lower than 50 volume % and not higher than 90 volume % or not lower than 40 volume % and not higher than 85 volume %, characterized in that the cBN sintered body contains alumina and zirconia not lower than 9 volume % and not higher than 50 volume % and a weight ratio of zirconia/alumina is not lower than 0.1 and not higher than 4. A tool including the cBN sintered body according to the present invention in a portion involved with cutting achieves improved performance in working difficult-to-machine centrifugally cast iron as compared with a conventional tool made of a cBN sintered body, because the cBN sintered body is excellent in strength, hardness and toughness.

### TECHNICAL FIELD

The present invention relates to a cBN sintered body for working cast iron, and particularly to a cBN sintered body for working centrifugally cast iron highly difficult to machine and to a tool made of the cBN sintered body.

### BACKGROUND ART

Conventionally, cubic boron nitride has high hardness second to diamond and excellent thermal conductivity, and it is lower in affinity with iron than diamond. Therefore, a tool material mainly composed of cubic boron nitride has been used for a tool for finish-cutting of quenched steel or cast iron.

For example, Patent Document 1 discloses a sintered body containing 50 to 80 volume % cubic boron nitride and 50 to 20 volume % binder phase, the binder phase being formed of at least one titanium compound selected from the group consisting of TiC, TiN and TiCN and aluminum, and the aluminum content in the binder phase being 30 to 70 volume %. This sintered body is used for high-speed cutting of cast iron.

In addition, Patent Document 2 discloses a wear-resistant sintered body making use of such characteristics of Al₂O₃ as oxidation resistance and chemical stability, that is formed of 30 to 70 volume % cubic boron nitride, 20 to 50 volume % Al₂O₃, and at least one of a carbide and a nitride of a transition metal of 10 to 30 volume %.

Moreover, Patent Document 3 discloses a sintered body additionally containing zirconia. The sintered body disclosed herein is composed of 40 to 70 volume % powdery particles of cubic boron nitride, 15 to 45 volume % titanium nitride serving as a main component of a binder phase, and 15 to 35 volume % powdery particle mixture of Al₂O₃, ZrO₂, AlN, and needle-crystal SiC serving as a sub component of the binder phase, the sub component of the binder phase above being composed of 50 to 65 volume % Al₂O₃, 1 to 5 volume % ZrO₂, 20 to 40 volume % MN, and 5 to 15 volume % needle-crystal SiC. This sintered body achieves improved capability of the binder phase to hold powdery particles of cubic boron nitride and improved wear resistance at a high temperature in cutting or plastic working of a high-hardness material such as quenched steel or cemented carbide, a heat-resistant alloy, and the like.

### Patent Document 1: Japanese Patent Laying-Open No. 2000-44348

### Patent Document 2: Japanese Patent Laying-Open No. 7-172923

### Patent Document 3: Japanese Patent No. 2971203

### DISCLOSURE OF THE INVENTION

### Problems to be Solved by the Invention

Demand for centrifugally cast iron particularly as a material for a cylinder liner of an engine of an automobile has increased because of its excellent mechanical characteristics and low cost. A structure of this centrifugally cast iron includes flake graphite pearlite as in sand-cast iron or the like.

On the other hand, as pearlite is fine, the cast iron is difficult to machine. This may be because the cast iron has a microstructure and hence thermal conductivity tends to be low. Accordingly, heat is concentrated in a cutting edge during cutting and cast iron and a component in the cutting edge react with each other due to a high temperature, which results in rapid progress of wear of the sintered body disclosed in Patent Document 1 above.

In addition, in the sintered body additionally containing Al₂O₃ excellent in resistance to chemical reaction as measures against wear as disclosed in Patent Document 2, in working difficult-to-machine centrifugally cast iron, chipping is more likely in a cutting edge due to mechanical and thermal impact of the microstructure on the cutting edge because toughness of Al₂O₃ is low and thermal conductivity is low.

Patent Document 3 above discloses a sintered body achieving improved toughness through addition of Al₂O₃, ZrO₂, and needle-crystal SiC to improve a degree of sintering. This sintered body, however, aims to reduce cracks potentially caused in the sintered body during fabrication of the sintered body, but not to reduce cracks caused during cutting, and this sintered body does not exhibit sufficient toughness in working centrifugally cast iron.

Therefore, for working difficult-to-machine centrifugally cast iron, a material having further improved wear resistance and chipping resistance as compared with the conventional sintered body has been required. An object of the present invention is to provide a cBN composite sintered body having longer life in working centrifugally cast iron.

### Means for Solving the Problems

In order to achieve the object above, it was found that a cutting tool made of a cubic boron nitride composite sintered body obtained by sintering raw material powders composed of 50 to 90 volume % cubic boron nitride (cBN component), 1 to 20 volume % TiC, and 9 to 50 volume % combined Al₂O₃ and ZrO₂ or raw material powders composed of 40 to 85 volume % cubic boron nitride, 0.5 to 15 volume % TiCN, and 9 to 50 volume % combined Al₂O₃ and ZrO₂ at a pressure not lower than 4 GPa and not higher than 7 GPa and at a temperature from 1200 to 1950° C. exhibits excellent performance in cutting difficult-to-machine centrifugally cast iron.

Here, the content of cubic boron nitride in the sintered body raw material is set to 50 to 90 volume % and preferably to 55 to 70 volume %. When the content of the cBN component is lower than 50 volume %, strength is insufficient in cutting difficult-to-machine cast iron and the cutting edge is chipped. Alternatively, when the content of the cBN component is higher than 90 volume %, reaction between cubic boron nitride and iron which is a work material is more likely due to heat generated during cutting and wear tends to progress.

In addition, the content of cubic boron nitride in the sintered body raw material in a case where a binder contains TiCN is set to 40 to 85 volume %. By setting the content of the cBN component in the range above, sufficient strength in cutting difficult-to-machine cast iron can be obtained and chipping of the cutting edge can be suppressed. Further, thermal wear is lessened.

A binder will now be described. The content in the sintered body raw material, of TiC in the binder is set to 1 to 20 volume % or lower and preferably set to 1 to 10 volume %. In addition, the content of TiCN is set to 0.5 to 15 volume % and preferably to 0.5 to 8 volume %. It is considered that, when the content of TiC is lower than 1 volume % or the content of TiCN is lower than 0.5 volume %, characteristics of TiC or TiCN effective to prevent reaction of cubic boron nitride with iron are not made use of and wear in the cutting edge of the tool tends to progress.

Moreover, the content of Al₂O₃ and ZrO₂ in the sintered body raw material is set to 9 to 50 volume % or lower and preferably to 15 to 30 volume %. The content of Al₂O₃ and the like is set in the range above for the following reasons.

Progress of wear due to reaction between cast iron and the component in the cutting edge can be prevented by making use of such properties of Al₂O₃ as oxidation resistance and chemical stability. On the other hand, though Al₂O₃ is high in hardness, it is low in toughness. Accordingly, chipping in the cutting edge is more likely when only Al₂O₃ is contained.

In order to solve this problem, ZrO₂ is added for the purpose of improving toughness. A single substance of ZrO₂ is great in volume change during phase transition from cubic crystal through tetragonal crystal to monoclinic crystal as a temperature lowers, and the volume significantly changes during cooling to a room temperature from a high temperature in sintering, which results in a crack in the sintered body. Therefore, a single substance of ZrO₂ is not suitable for use in a raw material to be sintered. Here, in general, partially stabilized zirconia to which a stabilizing material such as Y₂O₃, MgO, CaO, or ReO is added and in which a stable region of cubic crystals in a high-temperature stable phase or tetragonal crystals in an intermediate phase extends toward a low temperature and cubic crystals or tetragonal crystals are present in a stable state even at a room temperature is employed.

It has been known that each stabilizing material has its specific, proper amount to be added. For example, regarding a stabilizing material Y₂O₃, flexural strength of partially stabilized zirconia is maximized when 3 mol % Y₂O₃ is added and K_{I}C decreases when 3 mol % or more Y₂O₃ is added. According to the present invention, it was found that, even when raw material powders to which a stabilizing material in an amount different from a proper amount at which performance of partially stabilized zirconia is most exhibited is added are employed, zirconia is stabilized more sufficiently than in a case of use of a conventional stabilizing material such as Y₂O₃, by sintering the raw material powders together with cBN, TiC or TiCN representing other raw material powders at a super-high pressure so that any one of cubic crystals and tetragonal crystals or both of them combined can be present.

Here, primary characteristics of partially stabilized zirconia are as follows: flexural strength at room temperature in a range from 750 MPa to 1800 MPa and flexural strength at 1000° C. of 300 MPa; and fracture toughness K_{I}C in a range from 8 to 12 MPa·m^{-1/2}.

A mechanism of ZrO₂ capable of improving toughness is as follows. When a great stress is applied to partially stabilized zirconia having such a structure that cubic crystals or tetragonal crystals are both present at a temperature around a room temperature, phase transition of tetragonal particles to monoclinic crystals occurs with their volume expanding. Cracks created in large stress field are pressed and crushed by this volume expansion and consequently development of cracks is prevented. Therefore, chipping resistance can be enhanced.

From X-ray diffraction measurement of the sintered body according to the present invention, it can be seen that not only cubic crystals and tetragonal crystals but also monoclinic crystals are present in the crystal structure of zirconia in the sintered body, although an amount of monoclinic crystals is small. This may be because partial stabilization of all zirconia particles was insufficient during cooling after sintering while cubic crystals and tetragonal crystals are both present and phase transition to monoclinic crystals of some particles occurred during cooling, as described above.

In phase transition to monoclinic crystals, however, volume expands by approximately 4.6%. Accordingly, generation of microcracks around where monoclinic crystals are present is highly likely.

Therefore, in order to maintain performance as a cutting tool, it is required to limit abundance of monoclinic crystals, and it seems desirable in view of the result of X-ray diffraction measurement that peak of monoclinic crystal does not exist, or even though peak exists, a peak intensity ratio {I_{monoclinic}(11 1̅)+I_{monoclinic}(111)}/{I_{tetragonal}(100)+I_{cubic}(111)} is not higher than 0.4.

Namely, a cBN sintered body and a tool made of a cBN sintered body according to the present invention adopt the features below.

i) A cBN sintered body for a cutting tool having at least a cutting portion formed of a cBN component and a binder as a raw material, the raw material containing the cBN component not lower than 50 volume % and not higher than 90 volume %, the binder containing TiC not lower than 1 volume % and not higher than 20 volume % and Al₂O₃ and ZrO₂ not lower than 9 volume % and not higher than 50 volume % in the raw material, and a weight ratio of ZrO₂/Al₂O₃ being not lower than 0.1 and not higher than 4.

ii) A cBN sintered body for a cutting tool having at least a cutting portion formed of a cBN component and a binder as a raw material, the raw material containing the cBN component not lower than 40 volume % and not higher than 85 volume %, the binder containing TiCN not lower than 0.5 volume % and not higher than 15 volume % and Al₂O₃ and ZrO₂ not lower than 9 volume % and not higher than 50 volume % in the raw material, and a weight ratio of ZrO₂/Al₂O₃ being not lower than 0.1 and not higher than 4.

iii) The cBN sintered body described in i) or ii) above, in which Al₂O₃ and ZrO₂ contained as the binder have an average particle size not greater than 5.0 μm and a crystal structure in ZrO₂ is formed from at least any one of cubic crystals and tetragonal crystals or both of them combined.

iv) The cBN sintered body described in i) to iii) above, in which monoclinic crystals are present in the cBN sintered body in such a state that, in X-ray diffraction measurement, peak of monoclinic crystal does not exist, or even though the peak exists, a peak intensity ratio {I_{monoclinic}(11 1̅)+I_{monoclinic}(111)}/{I_{tetragonal}(100)+I_{cubic}(111)} is not higher than 0.4.

(v) The cBN sintered body described in any of i) to iv) above, in which the raw material is sintered at a pressure not lower than 4 GPa and not higher than 7 GPa and at a temperature not lower than 1200° C. and not higher than 1950° C.

(vi) The cBN sintered body described in any of i) to v) above, in which the binder contains as remainder, one, or two or more selected from a carbide and a nitride of a transition metal of group 4a, 5a, or 6a in a periodic table as raw material powders.

(vii) A cutting tool made of a cBN sintered body, in which the cBN sintered body described in any of i) to vi) above is joined to a substrate through integral sintering or with a brazing material, and the substrate is made of cemented carbide, cermet, ceramics, or an iron-based material.

### EFFECTS OF THE INVENTION

The cBN sintered body according to the present invention is excellent in wear resistance as a result of addition of Al₂O₃ having such characteristics as oxidation resistance and chemical stability and it achieves improved toughness and excellent chipping resistance as a result of further addition of ZrO₂. A tool achieving both of improved wear resistance and chipping resistance particularly in working difficult-to-machine centrifugally cast iron is obtained.

### BEST MODES FOR CARRYING OUT THE INVENTION

An embodiment of the present invention will be described hereinafter with reference to examples, however, the examples below are for illustration only and do not intend to limit the present invention.

### Example 1

Raw materials having compositions shown in Table 1 were mixed to fabricate raw material powders. In samples Nos. 1 to 21 (except for 6, 5, and 13), TiN, Al, or the like was mixed as binder remainder, in addition to cBN, TiC, ZrO₂, and Al₂O₃. These samples were sintered at a pressure of 5.5 GPa and at a temperature of 1350° C. For comparison, No. 15 containing only Al₂O₃ and No. 18 containing only ZrO₂ were fabricated as a material in which both of Al₂O₃ and ZrO₂ are not mixed.

In addition, regarding raw material powders of Al₂O₃, Al₂O₃ powders having an average particle size of 0.5 μm were used for samples except for samples Nos. 19 and 20, Al₂O₃ powders having an average particle size of 5 μm were used for sample No. 19 and Al₂O₃ powders having an average particle size of 6 μm were used for sample No. 20.

The sintered bodies having compositions shown in Table 1 were worked into cutting inserts complying with ISO standard SNGN090312 and a portion having an inner diameter φ 85 mm of a cylindrical centrifugally cast iron liner was used to conduct a continuous inner-diameter cutting test.

Cutting conditions were such that a cutting speed was set to 900 m/min., a cutting depth was set to 0.3 mm, a feed rate was set to 0.2 mm/rev., and wet cutting was adopted [coolant: Emulsion (manufactured by Japan Fluid System as a trade name System Cut 96), 20-times diluted]. After cutting by a distance of 10 km and 12 km, the cutting edge was observed. Presence/absence of chipping and a flank face wear amount V_{B} after cutting by a distance of 10 km as well as a wear type and a chipping condition after cutting by a distance of 12 km were observed, and results thereof are also shown in Table 1.

As seen in the results shown in Table 1, wear of a blade of the tool according to the present invention normally progresses and flank face wear amount V_{B} can be suppressed to 250 μm or smaller. Both of Nos. 15 and 18 chipped after V_{B} exceeded 250 μm. Observing a worn portion in the cutting edge with an SEM after cutting, wear due to accumulation of streaky wear like a scratch was generated in No. 15 to which ZrO₂ was not added. On the other hand, in the materials other than No. 15, to which ZrO₂ was added, streaky wear like a scratch in a worn portion was less and even wear (normal wear) was observed. This streaky wear is dependent on an amount of addition of ZrO₂. Namely, evenness was better in the order of Nos. 18, 17, 16, and 15, and the worn portion in No. 18 was evenest.

It is assumed from the results of the test above that, out of wear due to heat and wear due to mechanical impact, mechanical wear is dominant in cutting of centrifugally cast iron and that small chipping results as a streaky scratch due to mechanical impact and wear progresses.

Therefore, it is estimated that, in the material to which ZrO₂ was added, even when a microcrack is generated due to mechanical impact, cubic and tetragonal ZrO₂ makes phase transition to monoclinic crystals with its volume expanding as stress is applied by developing microcracks, which leads to pressing and crushing of the microcracks, and thus development of microcracks was suppressed and chipping did not occur.

In No. 18 to which only ZrO₂ was added, wear like a scratch was not generated, however, thermal wear was significant and V_{B} progressed to 250 μm or greater. ZrO₂ is a material low in thermal conductivity, as it is used as a heat-insulating ceramic material in such applications as a high-temperature furnace material or a crucible. Accordingly, heat is concentrated in the cutting edge during cutting and radiation of heat is less likely. Then, the temperature of the cutting edge becomes higher and the cBN component in the sintered body reacts with the iron component in the work material. Consequently, it is estimated that thermal wear is great in a sample to which a large amount of ZrO₂ was added.

As seen in the results of Nos. 19 and 20, in the sample in which Al₂O₃ having a particle size exceeding 5 μm was used as raw material powders, a wear amount was substantially the same as that of No. 1 because the composition is the same as No. 1, however, chipping occurred. It is estimated that chipping occurred because Al₂O₃ in a coarse particle state in a blade fell under load during cutting.

As seen in the results of Nos. 3, 4, 5, and 6, the sample in which the content of cBN is less than 50 volume % has insufficient strength and chipped (No. 3). On the other hand, in a sample where the content of cBN is greater than 90 volume %, thermal reaction between cBN and the work material proceeds as a result of cutting heat and wear is great, which results in increased cutting resistance and chipping (No. 6).

As seen in the results of Nos. 7, 8, 9, and 10, in the sample where the content of TiC is less than 1 volume %, characteristics of TiC lower in affinity with iron than cBN are not made use of and thermal wear proceeds. Accordingly, wear developed to 250 μm or greater, cutting resistance increased, and chipping occurred (No. 7). On the other hand, in the sintered body of which TiC content is 20 volume % or greater, chipping in the cutting edge occurred due to brittleness of TiC (No. 10).

As seen in the results of Nos. 11, 12, 13, and 14, in the sample where the total content of Al₂O₃ and ZrO₂ is less than 9 volume %, an amount of addition of ZrO₂ is small, and hence such a wear type as streaky scratch was observed and wear developed to a wear amount of 250 μm or greater (No. 11). As the content of cBN is decreased when the total content of Al₂O₃ and ZrO₂ is greater than 50 volume %, strength is insufficient and chipping occurred (No. 14).

As seen in the test results above, the cutting tool made of the sintered body according to the present invention is a tool having a long life in working difficult-to-machine centrifugally cast iron, because improvement in chipping resistance as compared with No. 15 representing a conventional material and improvement in wear resistance as compared with No. 18 were confirmed.

In measurement of the sintered bodies having the compositions shown in Table 1 with an X-ray diffraction apparatus (Cu was used in an X-ray tube), peaks of cBN, TiC, TiCN, α-Al₂O₃, c-ZrO₂ (cubic), and t-ZrO₂ (tetragonal) were confirmed commonly among the sintered bodies except for No. 15. FIGS. 1, 2 and 3 show peak patterns in results of X-ray diffraction measurement of the sintered bodies having compositions indicated with Nos. 2, 17 and 21, as results of X-ray diffraction measurement of sintered bodies Nos. 2, 17 and 21, respectively.

Peak intensity of monoclinic crystals was further examined. As shown in FIG. 1, peak of m-ZrO₂ (monoclinic) does not exist in the X-ray diffraction peak of No. 2. No. 17 exhibits a peak intensity ratio of {I_{monoclinic}(11 1̅)+I_{monoclinic}(111)}/{I_{tetragonal}(100)+I_{cubic}(111)}=0.40. As shown in Table 1, ZrO₂ powders in which 5 wt % monoclinic ZrO₂ was mixed were used as the raw material powders in the sample No. 21. Therefore, as shown in FIG. 3, No. 21 exhibits a peak intensity ratio {I_{monoclinic}(11 1̅)+I_{monoclinic}(111)}/{I_{tetragonal}(100)+I_{cubic}(111)}=0.55. Namely, it can be seen that monoclinic ZrO₂ exists in the sintered body. In addition, the sintered bodies Nos. 2, 17 and 21 were worked into inserts as above, which were subjected to a test of continuous inner-diameter cutting of a cylindrical centrifugally cast iron liner.

As a result, regarding damage in the cutting edge after cutting by a distance of 10 km, as shown in Table 1, the sintered bodies having compositions of Nos. 2 and 17 exhibited normal wear, that is, flank face wear amounts of V_{B}=175 μm and 198 μm respectively, whereas the sintered body having the composition of No. 21 exhibited V_{B}=187 μm after cutting by a distance of 10 km and small chipping occurred.

Thus, it is assumed that greater abundance of monoclinic ZrO₂ led to less volume expansion brought about by stress transformation, and development of a microcrack could not be suppressed and chipping occurred.

TABLE 1
unit: [volume %]

| | | | | | | Flank Face | |
|---|---|---|---|---|---|---|---|
| | | | Total of | | Vickers | Wear V_{B} [μm] | Wear Type and |
| Sample | | | Al₂O₃ and | ZrO₂/ | Hardness | After 10 km | Chipping Condition |
| No. | cBN | TiC | ZrO₂ | Al₂O₃ | (Hv) | Cutting | After 12 km Cutting |
| 1 | 70 | 3 | 17 | 2.5 | 2863 | 157 | Normal wear |
| 2 | 70 | 3 | 18 | 1 | 2906 | 175 | Normal wear |
| 3 | 40 | 5 | 28 | 2.5 | 2183 | Chipped | — |
| 4 | 50 | 5 | 28 | 2.5 | 2310 | 165 | Normal wear |
| 5 | 90 | 1 | 9 | 2.5 | 3474 | 246 | Normal wear |
| 6 | 95 | 0.5 | 4.5 | 2.5 | 3598 | 302 | Chipped |
| 7 | 80 | 0.1 | 17 | 2.5 | 2998 | 296 | Chipped |
| 8 | 80 | 1 | 17 | 2.5 | 3040 | 237 | Normal wear |
| 9 | 60 | 20 | 13 | 2.5 | 2879 | 223 | Normal wear |
| 10 | 60 | 30 | 9 | 2.5 | 2670 | Chipping | — |
| | | | | | | occurred | |
| 11 | 80 | 8 | 5 | 2.5 | 3012 | 283 | Scratch (streaky wear) |
| | | | | | | | · Chipping |
| 12 | 75 | 8 | 9 | 2.5 | 2895 | 211 | Normal Wear |
| 13 | 50 | 1 | 49 | 2.5 | 2281 | 242 | Normal wear |
| 14 | 40 | 3 | 55 | 2.5 | 2144 | Chipped | — |
| 15 | 70 | 3 | 20 | Only | 2807 | 279 | Scratch (streaky wear) |
| | | | | Al₂O₃ | | | · Chipped |
| 16 | 70 | 3 | 20 | 0.1 | 2792 | 182 | Slight streaky wear but |
| | | | | | | | not chipped |
| 17 | 70 | 3 | 20 | 4.0 | 2728 | 198 | Normal wear |
| 18 | 70 | 3 | 20 | Only | 2598 | 293 | Chipped |
| | | | | ZrO₂ | | | |
| 19 | 70 | 3 | 17 | 2.5 | 2647 | 165 | Normal wear |
| | | | Al₂O₃ having | | | | |
| | | | average | | | | |
| | | | particle size | | | | |
| | | | of 5 μm was | | | | |
| | | | used | | | | |
| 20 | 70 | 3 | 17 | 2.5 | 2558 | 168 | Chipping |
| | | | Al₂O₃ having | | | | |
| | | | average | | | | |
| | | | particle size | | | | |
| | | | of 6 μm was | | | | |
| | | | used | | | | |
| 21* | 70 | 3 | 18 | 1 | 2654 | 187 | Small chipping |

*No. 21 includes ZrO₂ powders mixed with 5 wt % monoclinic ZrO₂ as raw material powders.

### Example 2

Raw materials having compositions shown in Table 2 were mixed to fabricate raw material powders. In samples Nos. 1 to 9, TiN, Al, or the like was mixed as binder remainder in addition to cBN, TiC, ZrO₂, and Al₂O₃. These samples were sintered under sintering conditions shown in Table 2, respectively. The obtained sintered bodies were worked into cutting inserts complying with ISO standard SNGN090312, a work material obtained by cutting a cylindrical centrifugally cast iron liner having an outer diameter φ 95 mm by a black coating thickness of approximately 0.5 mm was adopted, and a continuous outer-diameter cutting test was conducted.

Cutting conditions were such that a cutting speed was set to 900 m/min., a cutting depth was set to 1.0 mm, a feed rate was set to 0.5 mm/rev., and wet cutting was adopted [coolant: Emulsion (manufactured by Japan Fluid System as a trade name System Cut 96), 20-times diluted]. After cutting by a distance of 10 km and 12 km, the cutting edge was observed. Presence/absence of chipping after cutting by a distance of 10 km and flank face wear amount V_{B} after cutting as well as a wear type and a chipping condition after cutting by a distance of 12 km were observed, and results thereof are also shown in Table 2.

As seen in the results shown in Table 2, it is assumed that the structure of the sintered body was not sufficiently densified in No. 2 fabricated under such a condition that a pressure during sintering was lower than 4 GPa, and hence strength of the sintered body was lower and chipping was observed after cutting by a distance of 12 km. In addition, it is assumed that abnormal grain growth of ZrO₂ and TiC occurred in No. 5 due to the high pressure, that was fabricated under such a condition that a pressure during sintering was higher than 7 GPa, and hence strength of the sintered body was lower and chipping occurred. A type of damage after cutting by a distance of 12 km of the sintered body obtained under a sintering pressure condition from 4 to 7 GPa was normal wear.

In Nos. 6 and 9 fabricated under such sintering conditions as a sintering temperature lower than 1200° C. and a sintering temperature higher than 1950° C. respectively, the flank face wear amount was greater than in Nos. 7 and 8 and in addition, chipping occurred. This may be because the structure of sintered body No. 6 sintered at a sintering temperature not higher than 1200° C. was not densified, which resulted in low strength between cBN particles and vulnerability to mechanical impact.

In addition, it has been known that grain growth of stabilized zirconia, in particular, grain growth of cubic stabilized zirconia, rapidly proceeds at a temperature of 1400° C. or higher. It has been known that grain growth to a particle size of approximately 30 μm is achieved under a sintering condition at 1700° C. or higher, and therefore, it can be estimated that chipping occurred in No. 9 sintered at a temperature higher than 1950° C. because grain growth of ZrO₂ to a huge particle occurred and strength of the cBN sintered body was correspondingly lowered.

Thus, the cutting tool made of the sintered body according to the present invention serves as a tool having a longer life in working difficult-to-machine centrifugally cast iron, if the tool is fabricated under such sintering conditions as a sintering pressure not lower than 4 GPa and not higher than 7 GPa and a sintering temperature not lower than 1200° C. and not higher than 1950° C.

TABLE 2

| | | | | | | Flank Face | |
|---|---|---|---|---|---|---|---|
| | | | | Total of | | Wear V_{B} [μm] | Wear Type and |
| Sample | Sintering | | | Al₂O₃ and | ZrO₂/ | After 10 km | Chipping Condition |
| No. | Condition | cBN | TiC | ZrO₂ | Al₂O₃ | Cutting | After 12 km Cutting |
| 1 | 5.5 GPa, | 70 | 3 | 18 | 2.5 | 157 | Normal wear |
| | 1350° C. | | | | | | |
| 2 | 3 GPa, | 70 | 3 | 18 | 2.5 | 261 | Scratch (streaky |
| | 1200° C. | | | | | | wear)· Chipped |
| 3 | 4 GPa, | 70 | 3 | 18 | 2.5 | 244 | Normal wear |
| | 1250° C. | | | | | | |
| 4 | 7 GPa, | 70 | 3 | 18 | 2.5 | 218 | Normal wear |
| | 1900° C. | | | | | | |
| 5 | 7.5 GPa, | 70 | 3 | 18 | 2.5 | — | Chipped |
| | 1900° C. | | | | | | |
| 6 | 5.5 GPa, | 70 | 3 | 18 | 2.5 | 269 | Chipped |
| | 1150° C. | | | | | | |
| 7 | 5.5 GPa, | 70 | 3 | 18 | 2.5 | 244 | Normal wear |
| | 1200° C. | | | | | | |
| 8 | 5.5 GPa, | 70 | 3 | 18 | 2.5 | 218 | Normal wear |
| | 1950° C. | | | | | | |
| 9 | 5.5 GPa, | 70 | 3 | 18 | 2.5 | 272 | Chipped |
| | 2000° C. | | | | | | |

### Example 3

Here, cBN, Al₂O₃, ZrO₂, TiCN, Al, and Ti₂AlN representing raw materials of compositions shown in Table 3 were mixed and the mixture was sintered at 5.5 GPa and 1350° C. Table 3 shows not a composition but volume % of each compound measured in analysis of a sintered body.

The sintered bodies having the compositions shown in Table 3 were worked into cutting inserts complying with ISO standard SNGN090312, and a portion having an inner diameter φ 85 mm of a cylindrical centrifugally cast iron liner was used to conduct a continuous inner-diameter cutting test.

Cutting conditions were such that a cutting speed was set to 900 m/min., a cutting depth was set to 0.3 mm, a feed rate was set to 0.2 min/rev., and wet cutting was adopted [coolant: Emulsion (manufactured by Japan Fluid System as a trade name System Cut 96), 20-times diluted]. After cutting by a distance of 10 km and 12 km, the cutting edge was observed. Presence/absence of chipping after cutting by a distance of 10 km and flank face wear amount V_{B} after cutting as well as a wear type and a chipping condition after cutting by a distance of 12 km were observed, and results thereof are also shown in Table 3.

As seen in the results shown in Table 3, in the tool made of the cBN sintered body according to the present invention, wear in the blade normally progressed and flank face wear amount V_{B} could be suppressed to 250 μm or smaller. No. 2 achieved improved strength and suppressed chipping as compared with No. 19, because TiC in the raw material mixture was replaced with TiCN, and No. 2 exhibited normal wear.

As in the results of Nos. 3, 4, 5, and 6 in Example 1, Nos. 1, 2, 3, and 4 were insufficient in strength and chipping occurred when the cBN content is less than 30 volume %, and when the cBN content is higher than 90 volume %, thermal reaction with cBN caused by cutting heat leads to progress of wear, which results in increased cutting resistance and chipping.

As seen in the results of Nos. 5, 6, 7, and 8, when the content of TiCN is less than 1 volume %, flank face wear progresses and chipping occurs. This may be because TiCN accelerates reaction between cBN and Al₂O₃, ZrO₂. On the other hand, the sintered body in which TiCN content is 15 volume % or higher chipped due to brittleness of TiCN.

In Nos. 9, 10, 11, and 12, when the total content of Al₂O₃ and ZrO₂ is less than 9 volume %, addition of ZrO₂ is less, and therefore, strength was lower and chipping occurred. When the total content of Al₂O₃ and ZrO₂ is equal to or higher than 50 volume %, the content of cBN is less, and therefore, strength was insufficient and chipping occurred, which is the same result as in Nos. 11, 12, 13, and 14 in Example 1.

In measurement of the sintered bodies having the compositions shown in Table 3 with an X-ray diffraction apparatus (Cu was used in an X-ray tube), peak of cBN, TiCN, α-Al₂O₃, c-ZrO₂ (cubic), t-ZrO₂ (tetragonal), TiB₂, AlB₂, and AlN could be confirmed commonly among the sintered bodies except for No. 17.

TABLE 3

| | | | Total of | | Vickers | Flank Face | Wear Type and |
|---|---|---|---|---|---|---|---|
| Sample | | | Al₂O₃ and | ZrO₂/ | Hardness | Wear V_{B} After | Chipping Condition |
| No. | cBN | TiCN | ZrO₂ | Al₂O₃ | (Hv) | 10 km Cutting | After 12 km Cutting |
| 1 | 30 | 5 | 40 | 2.5 | 1989 | Chipped | — |
| 2 | 40 | 5 | 40 | 2.5 | 2153 | 186 | Normal wear |
| 3 | 85 | 1 | 9 | 2.5 | 3315 | 243 | Normal wear |
| 4 | 90 | 0.5 | 9 | 2.5 | 3531 | 293 | Chipped |
| 5 | 70 | 0 | 20 | 2.5 | 2789 | Chipped | — |
| 6 | 70 | 0.5 | 20 | 2.5 | 2817 | 243 | Normal wear |
| 7 | 55 | 15 | 10 | 2.5 | 2853 | 213 | Normal wear |
| 8 | 50 | 30 | 10 | 2.5 | 2621 | 236 | Streaky wear · |
| | | | | | | | Chipping |
| 9 | 80 | 8 | 5 | 2.5 | 2992 | 302 | Chipping |
| 10 | 80 | 8 | 9 | 2.5 | 2997 | 229 | Normal Wear |
| 11 | 45 | 1 | 50 | 2.5 | 2215 | 245 | Normal Wear |
| 12 | 40 | 3 | 55 | 2.5 | 2123 | 276 | Chipped |
| 13 | 60 | 3 | 25 | Only | 2793 | 197 | Chipped |
| | | | | Al₂O₃ | | | |
| 14 | 60 | 3 | 25 | 0.1 | 2782 | 175 | Normal wear |
| 15 | 60 | 3 | 25 | 4 | 2711 | 183 | Normal wear |
| 16 | 60 | 3 | 25 | Only | 2575 | 203 | Chipped |
| | | | | ZrO₂ | | | |
| 17 | 0 | 0 | 100 | 2.5 | 1895 | Chipped | — |
| 18 | 0 | 10 | 90 | 2.5 | 1913 | 293 | Chipped |
| 19 | 40 | 5* | 40 | 2.5 | 2213 | Chipped | — |

*No. 19 includes TiC powders as raw material powders, instead of TiCN powders.

### BRIEF DESCRIPTION OF THE DRAWINGS

FIG. 1 is a diagram showing a peak pattern as a result of X-ray diffraction measurement of No. 2.

FIG. 2 is a diagram showing a peak pattern as a result of X-ray diffraction measurement of No. 17.

FIG. 3 is a diagram showing a peak pattern as a result of X-ray diffraction measurement of No. 21.

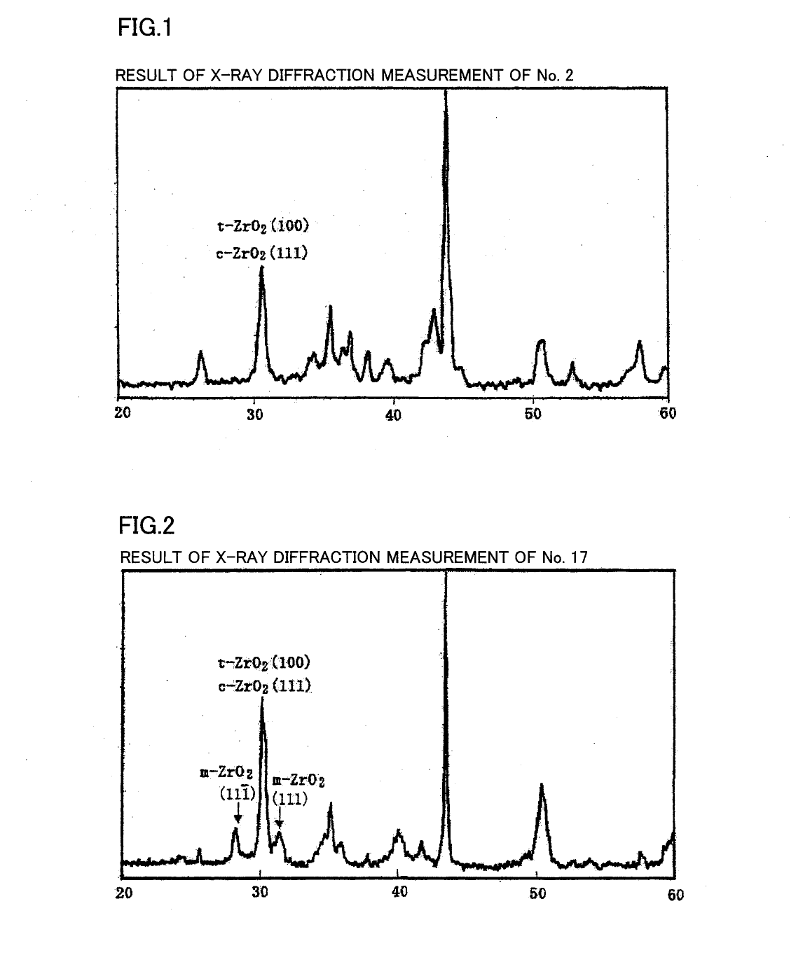

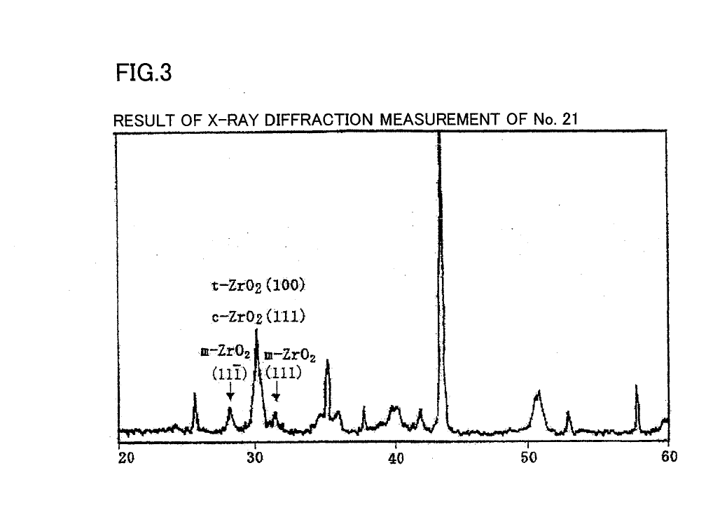

1. A cBN sintered body for a cutting tool having a cutting portion formed of a cBN component and a binder as a raw material, said raw material containing the cBN component not lower than 50 volume % and not higher than 80 volume %, said binder containing TiC not lower than 1 volume % and not higher than 20 volume % and Al₂O₃ and ZrO₂ not lower than 15 volume % and not higher than 50 volume % in said raw material, and a weight ratio of ZrO₂/Al₂O₃ being not lower than 0.1 and not higher than 4ₓ, wherein
monoclinic crystals of ZrO₂ are present in said cBN sintered body in such a state that, in X-ray diffraction measurement, peak of monoclinic crystal of ZrO₂ does not exist, or even though the peak exists, a peak intensity ratio {I_{monoclinic}(11 1̅)+I_{monoclinic}(111)}/{I_{tetragonal}(100)+I_{cubic}(111)} is not higher than 0.4.

2. A cBN sintered body for a cutting tool having a cutting portion formed of a cBN component and a binder as a raw material, said raw material containing the cBN component not lower than 50 volume % and not higher than 80 volume %, said binder containing TiCN not lower than 0.5 volume % and not higher than 15 volume % and Al₂O₃ and ZrO₂ not lower than 15 volume % and not higher than 50 volume % in said raw material, and a weight ratio of ZrO₂/Al₂O₃ being not lower than 0.1 and not higher than 4ₓ, wherein
monoclinic crystals of ZrO₂ are present in said cBN sintered body in such a state that, in X-ray diffraction measurement, peak of monoclinic crystal of ZrO₂ does not exist, or even though the peak exists, a peak intensity ratio {I_{monoclinic}(11 1̅)+I_{monoclinic}(111)}/{I_{tetragonal}(100)+I_{cubic}(111)} is not higher than 0.4.

3. The cBN sintered body according to claim 1 or 2, wherein
Al₂O₃ and ZrO₂ contained as said binder have an average particle size not greater than 5.0 μm and a crystal structure in ZrO₂ is formed from at least any one of cubic crystals and tetragonal crystals or both of them combined.

4. (canceled)

5. The cBN sintered body according to claim 1 or 2, wherein
said raw material is sintered at a pressure not lower than 4 GPa and not higher than 7 GPa and at a temperature not lower than 1200° C. and not higher than 1950° C.

6. The cBN sintered body according to claim 1 or 2, wherein
said binder contains as remainder, one, or two or more selected from a carbide and a nitride of a transition metal of group 4a, 5a, or 6a in a periodic table as raw material powders.

7. A cutting tool made of a cBN sintered body, wherein
the cBN sintered body according to claim 1 or 2 is joined to a substrate through integral sintering or with a brazing material, and said substrate is made of cemented carbide, cermet, ceramics, or an iron-based material.
